(19) United States
(12) Patent Application Publication
(10) Pub. No.: US 2013/0135225 A1
(43) Pub. Date: May 30, 2013

(54) POINTING DEVICE

(71) Applicants: WEI-KUANG LIANG, Tu-Cheng (TW); QUAN-GUANG DU, Shenzhen City (CN); CHUN TANG, Shenzhen City (CN)

(72) Inventors: WEI-KUANG LIANG, Tu-Cheng (TW); QUAN-GUANG DU, Shenzhen City (CN); CHUN TANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/584,746

(22) Filed: Aug. 13, 2012

(30) Foreign Application Priority Data
Nov. 29, 2011 (CN) 201110387174.4

(51) Int. Cl. G06F 3/041; G09G 5/08

(52) U.S. Cl. 345/173; 345/156

(57) ABSTRACT

A pointing device includes an elongated key, an enclosure, and a sensing module. The enclosure defines a through hole receiving the elongated key. The sensing module includes a bracket, and a key sensing board. The bracket includes a bracket body and two positioning protrusions protruding from the bracket body. The key sensing board includes two key switches. The key sensing board defines two positioning hole receiving the two positioning protrusions. The elongated key includes two recess portions receiving the two key switches, and the bracket is secured on an inner side of the enclosure.

### BACKGROUND

1. Technical Field

The present disclosure relates to a pointing device for notebook computers.

2. Description of Related Art

Notebook computers include a pointing device. The pointing device includes a left key and a right key. A circuit board corresponding to the left key and the right key is secured to a bracket by a screw. However, the operations can be laborious and time-consuming.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a pointing device.

FIG. 2 is similar to FIG. 1, but viewed from another aspect.

FIG. 3 is an exploded, isometric view of the sensing module of FIG. 1.

FIG. 4 is similar to FIG. 3, but viewed from another aspect.

FIG. 5 is an assembled view of FIG. 1.

FIG. 6 is similar to FIG. 5, but viewed from another aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

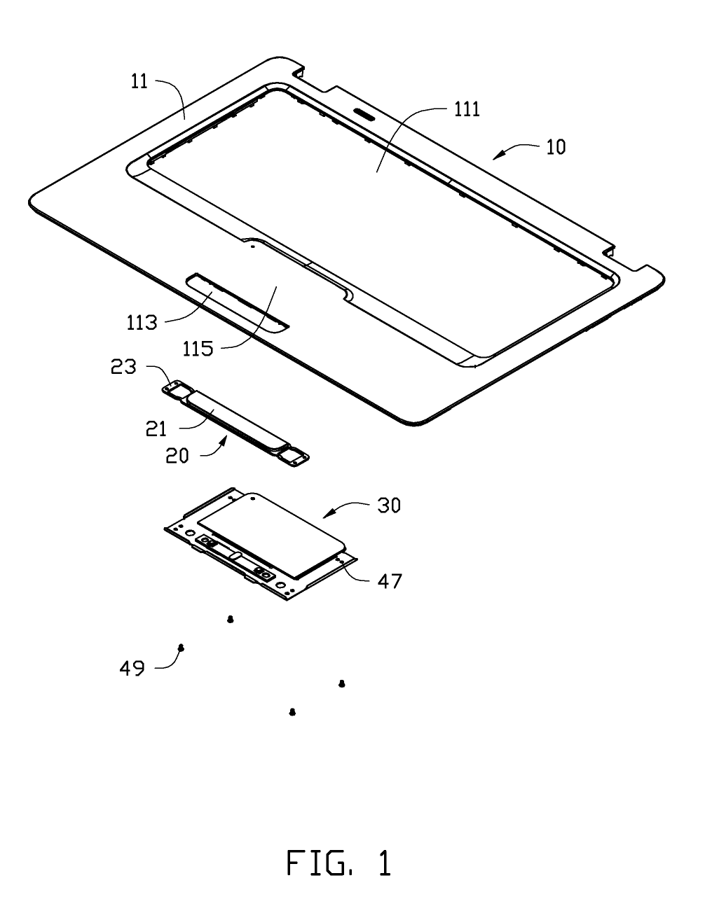

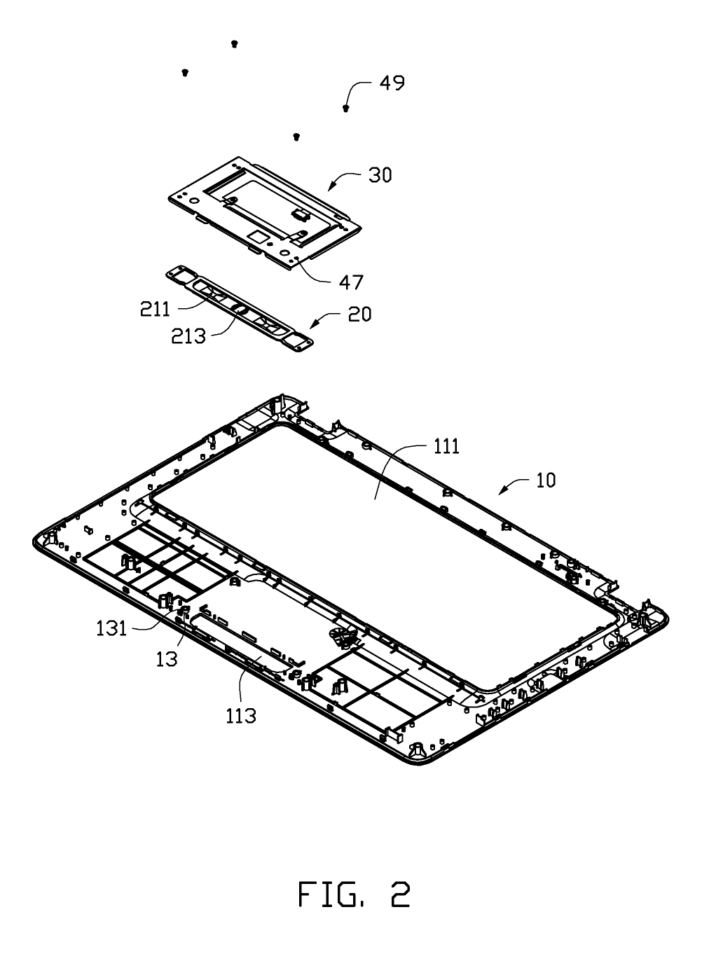

Referring to FIGS. 1 and 2, a pointing device, according to one embodiment, includes an enclosure 10, an elongated key 20, and a sensing module 30.

The enclosure 10 includes an enclosure body 11 and four securing posts 13 extending from the enclosure body 11. Each post 13 defines a securing hole 131. The enclosure body 11 defines a securing opening 111 for receiving a keyboard (not shown) and a through hole 113. The enclosure body 11 defines a touching part 115 located on an upper side of the through hole 113.

The elongated key 20 includes a key body 21 and two mounting portions 23 extending from opposite sides of the key body 21. The key body 21 defines two recess portions 211 and a receiving portion 213, located between the two recess portions 211. The key body 21 corresponds to the through hole 113.

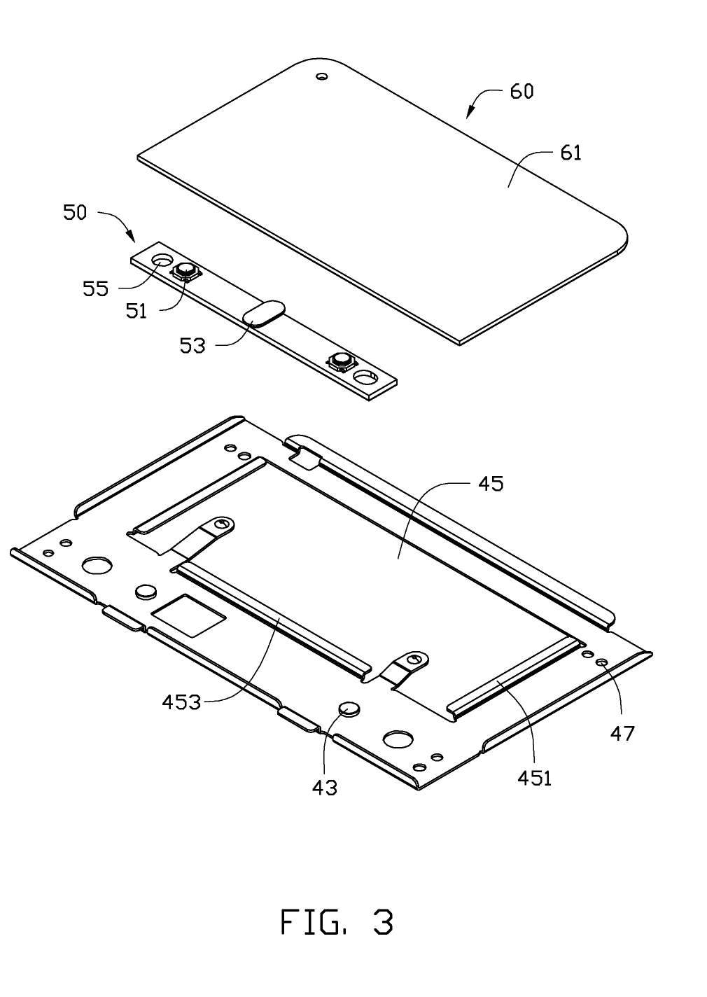

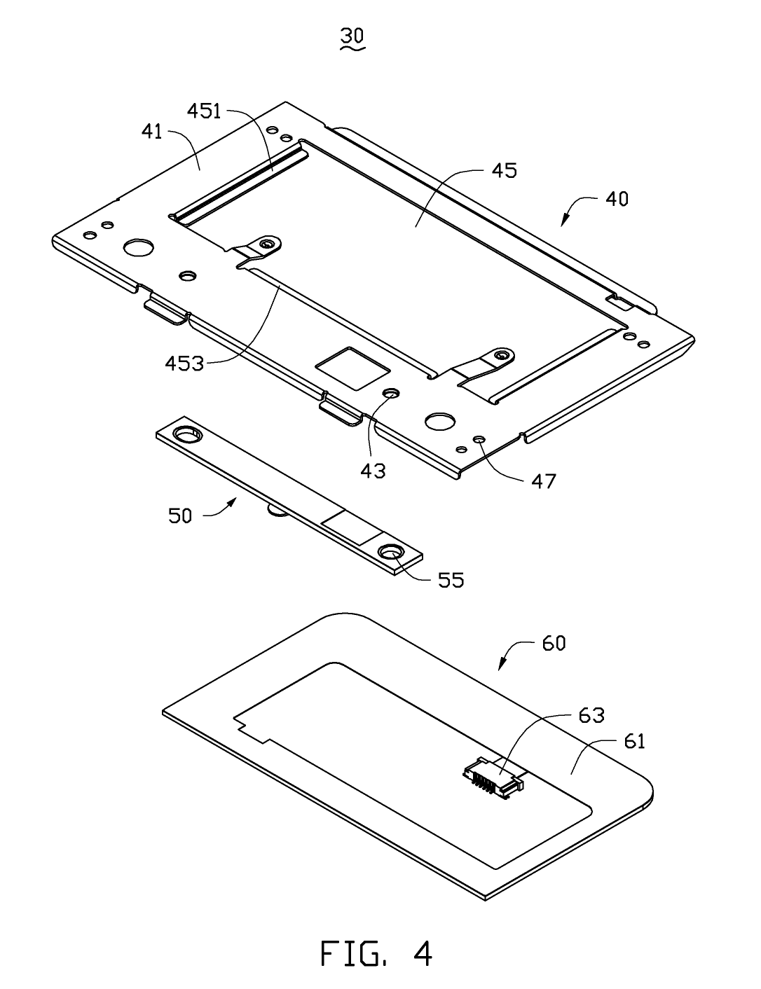

Referring to FIGS. 3 and 4, the sensing module 30 includes a bracket 40, a key sensing board 50, and a touch sensing board 60.

The bracket 40 includes a bracket body 41 and a positioning portion 43 protruding from the bracket body 41. In one embodiment, the positioning portion 43 is punched. The bracket 40 defines a rectangular mounting opening 45. The bracket 40 includes two first resisting tabs 451 extending from opposite edges of the mounting opening 45. The bracket 40 further includes a second resisting tab 453 extending from another edge of the mounting opening 45. The cross-section of the first resisting tab 451 and the second resisting tab 453 is substantially L-shaped. The bracket 40 defines four mounting holes 47 corresponding to the securing holes 131.

The key sensing board 50 includes two key switches 51 and a supporting protrusion 53, located between the two key switches 51. The key sensing board 50 defines two positioning holes 55. The two key switches 51 are located between the two positioning holes 55. The two key switches 51 are used for being received in the two recess portion 211 of the elongated key 20. The supporting protrusion 53 is used for being received in the receiving portion 213. In one embodiment, the two key switches 51 correspond to a left key and a right key of a mouse.

The touch sensing board 60 includes a sensing board body 61 and a connector 63, extending from the sensing board body 61. The connector 63 is used for sensing signals from the touch part 115 and sending the signals to a motherboard (not shown).

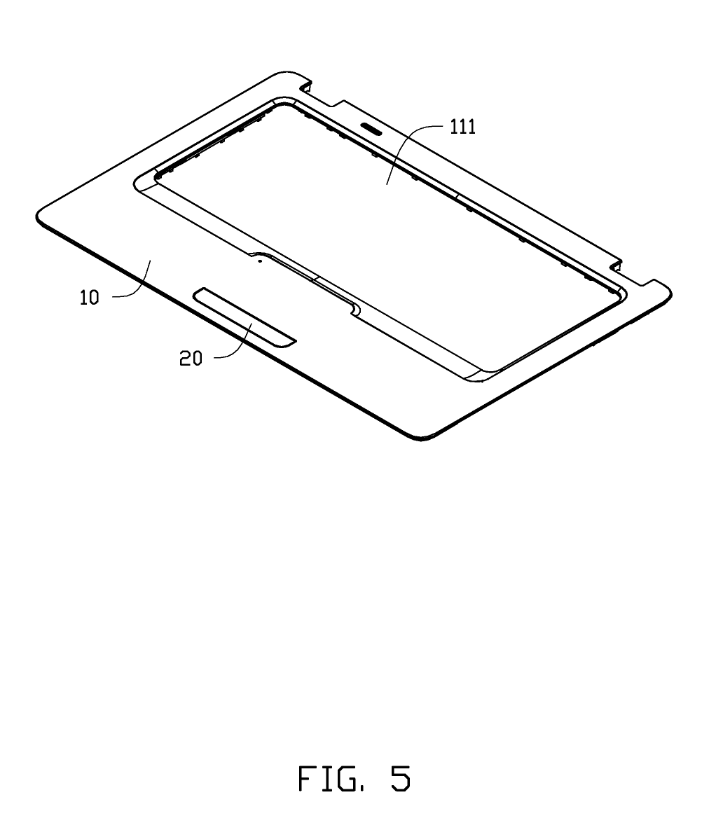

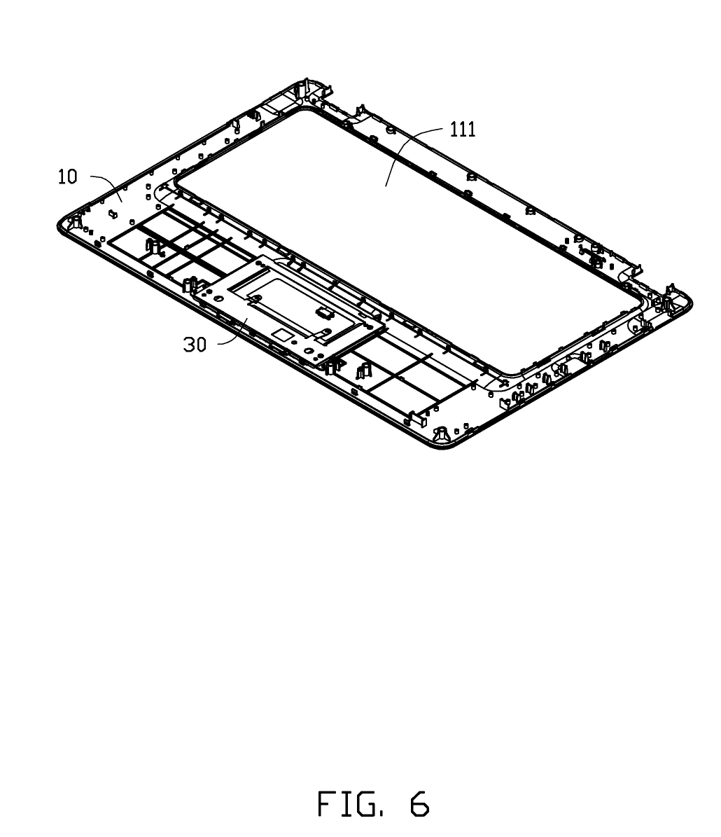

Referring to FIGS. 5 and 6, in assembly, the sensing board body 61 of the touch sensing board 60 is received between the two first resisting tabs 451 to enable the end of the sensing board body 61 to be received in the second resisting tab 453. At this time, the sensing board body 61 covers the mounting opening 45. The positioning holes 55 of the key sensing board 50 are aligned with the positioning portions 43 of the bracket 40. The key sensing board 50 moves toward the bracket 40 to enable the positioning portions 43 to be received in the positioning hole 55. Thus, the sensing module 30 is assembled.

The key body 21 of the elongated key 20 is received in the through hole 113 of the enclosure 10. The mounting portions 23 of the elongated key 20 are located on the inner side of the enclosure 10. The key switches 51 of the sensing module 30 and the supporting protrusion 53 are received in the two recess portion 211 and the receiving portion 213. The mounting holes 47 of sensing module 30 are aligned with the securing holes 131 of the enclosure 10. Four fasteners 49, such as screws, are screwed into the mounting holes and the securing holes 131 to secure the sensing module 30 to the enclosure 10. At this time, the touch sensing board 60 is located on the inner side of the touch part 115.

In one embodiment, the pointing device is applied to a notebook computer, and the enclosure 10 is an enclosure of the notebook computer.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A pointing device, comprising:
an elongated key, the elongated key comprises two recess portions;
an enclosure, the enclosure defines a through hole receiving the elongated key; and
a sensing module, the sensing module comprising:
a bracket, the bracket comprises a bracket body and two positioning protrusions protruding from the bracket body; and
a key sensing board, the key sensing board comprises two key switches and defines two positioning holes receiving the two positioning protrusions;
wherein the two recess portions receives the two key switches, and the bracket is secured to an inner side of the enclosure.

2. The pointing device of claim 1, wherein the key sensing board further comprises a supporting protrusion located between the two key switches, and the elongated key defines a receiving portion receiving the supporting protrusion.

3. The pointing device of claim 1, wherein the enclosure comprises a touch part; the sensing module further comprises a touch sensing board corresponding to the touch part; the bracket defines a mounting opening corresponding to the touch sensing board; the bracket comprises two first resisting tabs extending from opposite edges of the mounting opening; and the touch sensing board is located between the two first resisting tabs to cover the mounting opening.

4. The pointing device of claim 3, wherein a cross section of each first resisting tab is L-shaped.

5. The pointing device of claim 3, wherein the bracket further comprises a second resisting tab extending from another edge of the mounting opening, and the touch sensing board is received in the second resisting tab.

6. The pointing device of claim 5, wherein a cross section of the second resisting tab is L-shaped.

7. The pointing device of claim 3, wherein the enclosure defines a securing opening for receiving a keyboard, and the touch part is located between the securing opening and the through hole.

8. The pointing device of claim 1, wherein the enclosure comprises a plurality of securing posts; each securing post defines a securing hole; and the bracket defines a plurality of mounting holes corresponding to the securing holes.

9. A pointing device, comprising:
an elongated key, the elongated key comprising two recess portions;
an enclosure, the enclosure comprises a touch part and defines a through hole receiving the elongated key; and
a sensing module, the sensing module comprising:
a key sensing board, the key sensing board comprising two key switches; and
a touch sensing board contacting an inner side of the touch part to sense signals from the touch part.

10. The pointing device of claim 9, wherein the key sensing board further comprises a supporting protrusion located between the two key switches, and the elongated key defines a receiving portion receiving the supporting protrusion.

11. The pointing device of claim 9, wherein the sensing module further comprises a bracket; the touch sensing board and the key sensing board are mounted on the bracket; the bracket comprises a bracket body and two positioning protrusions protruding from the bracket body; and the key sensing board defines two positioning holes receiving the two positioning protrusions.

12. The pointing device of claim 11, wherein the bracket defines a mounting opening corresponding to the touch sensing board; the bracket comprises two first resisting tabs extending from opposite edges of the mounting opening; and the touch sensing board is located between the two first resisting tabs to cover the mounting opening.

13. The pointing device of claim 12, wherein a cross section of each first resisting tab is L-shaped.

14. The pointing device of claim 12, wherein the bracket further comprises a second resisting tab extending from another edge of the mounting opening, and the touch sensing board is received in the second resisting tab.

15. The pointing device of claim 14, wherein a cross section of the second resisting tab is L-shaped.

16. The pointing device of claim 12, wherein the enclosure defines a securing opening for receiving a keyboard, and the touch part is located between the securing opening and the through hole.

17. The pointing device of claim 11, wherein the enclosure comprises a plurality of securing posts; each securing post defines a securing hole; and the bracket defines a plurality of mounting holes corresponding to the securing holes.
